(19) United States
(12) Patent Application Publication
(10) Pub. No.: US 2008/0088132 A1
(43) Pub. Date: Apr. 17, 2008

(54) Wave rider

(76) Inventor: Walter Heinrich Laube von Laubenfels, Belcarra (CA)

Correspondence Address: WALTER LAUBE von LAUBENFELS, 3515 MAIN AVENUE, BELCARRA,BC, V3H4R2, omitted

(21) Appl. No.: 11/374,530

(22) Filed: Oct. 17, 2006

(51) Int. Cl. F03B 13/12; F03B 13/10; H02P 9/04

(52) U.S. Cl. 290/53

(57) ABSTRACT

The Wave Rider, comprised of three power generating units in a single aluminum housing, is designed to absorb the impact of the wave with its twin turbines which are connected to generators. The pressure on the entire apparatus activates power extraction from the rear-mounted pulleys through which cables connect the unit to the ocean floor on one end and a counterweight on the other. The power extraction acts as a break that forces the rear portion of the apparatus down. This downward movement is assisted by the Bernoulli effect, created by the unique design of the rear floats. Inside the rear portion of the apparatus are the cylinders in which floats riding up and down on worm-geared shafts that drive the generators atop. The tilting of the apparatus increases the distance these floats can travel beyond the height of the wave. The downward stroke of these floats receives added gravity from an innovative water ballast.

### BACKGROUND OF THE INVENTION

The diminishing reserves of the world's oil supplies coupled with the escalating demands for energy have made the need for alternative sources evident.

Global warning and pollution-related respiratory ailments only serve to underscore the imperative for clean, renewable energy.

The Wave Rider is a unique off-shore power generation apparatus designed to take advantage of wave propulsion as well as wave lift. By extracting power from the horizontal as well as the vertical impetus of the waves, it has an enormous advantage over competing systems and should prove the most cost-effective method of converting the potential energy of the oceans into electricity.

The potential energy of the world's oceans is virtually inexhaustible. A study by the State University of Oregon has revealed that a mere 0.2% of the potential energy of the Pacific Ocean alone can supply the energy needs of the entire world, if converted to electricity. The Wave Rider is designed to extract that energy in an economic manner.

### EMBODIMENT OF THE CURRENT INVENTION

The current embodiment of the wave capture system (Wave Rider) is best applied in shallow waters which offer reasonably constant wave breaks. Proximity to a shoreline will reduce transmission costs.

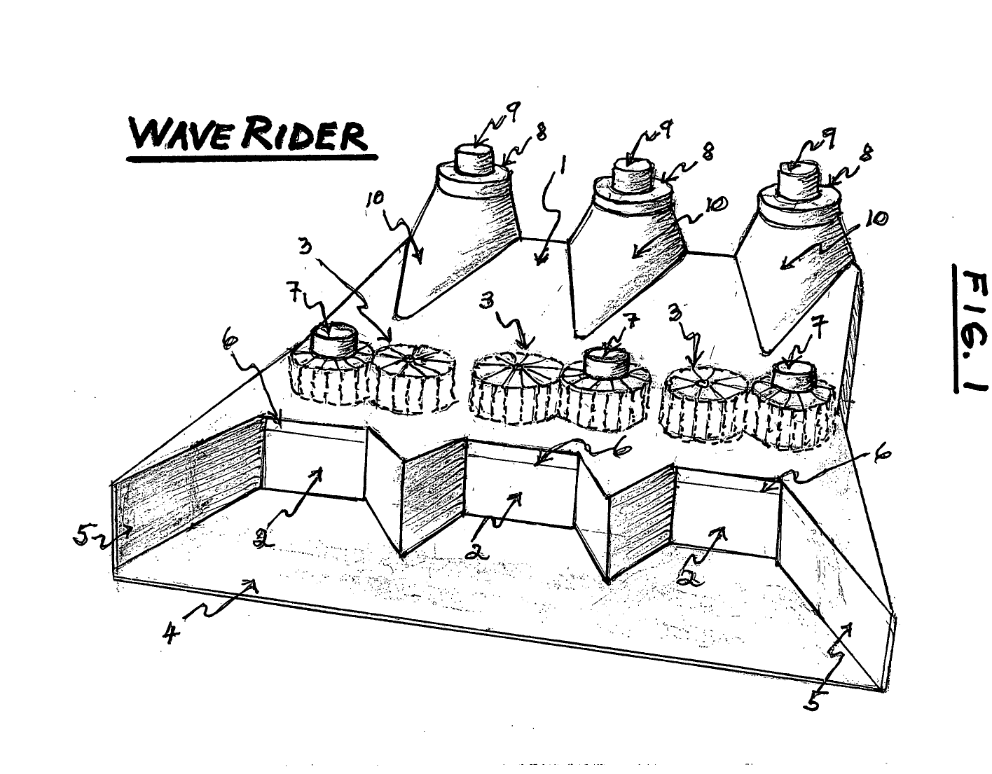

### FIG. 1

The Wave Rider power capture system shown in FIG. 1 is an aluminum structure (1) comprised of three individual units in one system with separate intakes (2) channeling the wave to the turbines (3).

A ramp (4) with converging side walls (5) will force a maximum volume of the wave into the turbines. A hinged gate (6) will absorb the initial impact of the wave and serve to set the turbines in motion before the full impact of the wave hits the blades. As the surging water of the wave passes through the turbines, the turning motion is transmitted to a generator (7) located atop each individual unit.

Once the water of the wave has passed the turbines, it flows to the rear of the channel, where a baffle deflects it and directs it into the base of a cylinder (8) containing a float.

The rising water level will result in a lifting motion which causes the float to spin a worm-geared pole which turns a generator (9) atop the superstructure (10). The V-shaped design of the superstructure is intended to deflect storm waves of unusual heights that might wash over the unit and could severely damage a light-weight structure that offered resistance. It also allows for excess water to accumulate inside the channel to give the float maximum lift.

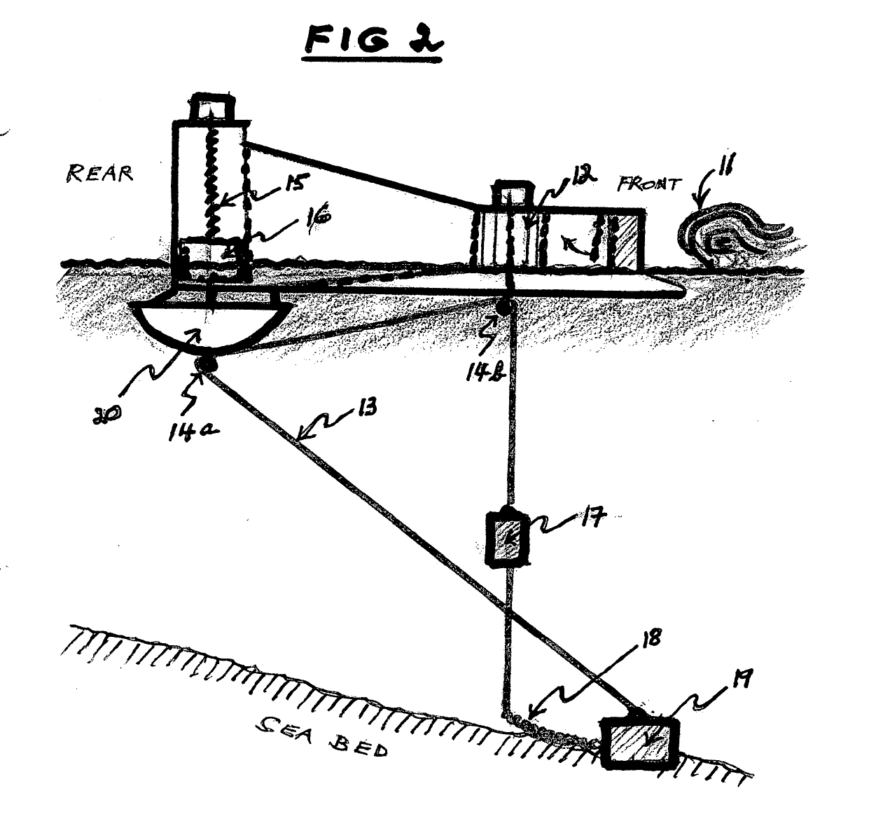

### FIG. 2

This figure shows an individual unit at rest during a wave interval. The approaching wave (11) will be forced up the ramp into the twin turbines (12). The resistance of the constricting access to the turbines will exert pressure on the entire apparatus. This pressure is increased by the restraining Kevlar cable (13) running through pulleys (14a+b) at the bottom of the apparatus. The power extracted from the rear pulley (14a) is transmitted to the generator atop by the worm-geared shaft (15) passing through the float (16). The front pulley (14b) supporting the counter weight (17) serves as an idler for subsequently retracting the apparatus. A heavy chain (18) connecting the cable to the 3 ton anchor (19) allows for extra movement in stormy conditions. The extraction of power at the rear pulley (14a) acts like a brake that is holding the unit against the pressure of the wave and is thus pulling the rear portion of the unit lower, which allows more water inside the unit to accumulate under the float, thus increasing its distance of upward travel beyond the normal range which is the height of the wave.

The configuration of the buoyancy tank (20) under the rear of the unit is designed to assist in forcing the rear of the unit downward by acting like an inverted airplane wing creating a Bernoulli effect when the water that passes under the structure sweeps along its top and bottom surfaces. Once the motion of the wave is past and the water is no longer sweeping its surfaces, it will serve again as a buoyancy tank that will lift the rear of the unit back to its original position.

Each of the three units of the apparatus will have the identical configuration attaching it to the seabed, thus providing stability in case of shifting winds causing a change in the direction of the incoming waves.

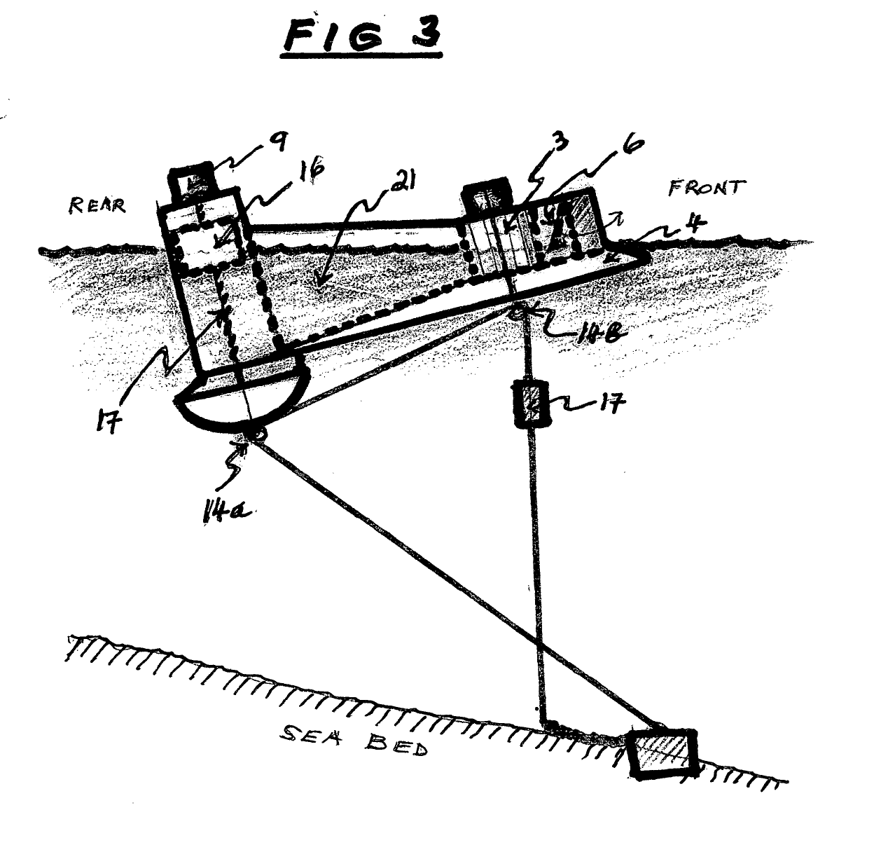

### FIG. 3

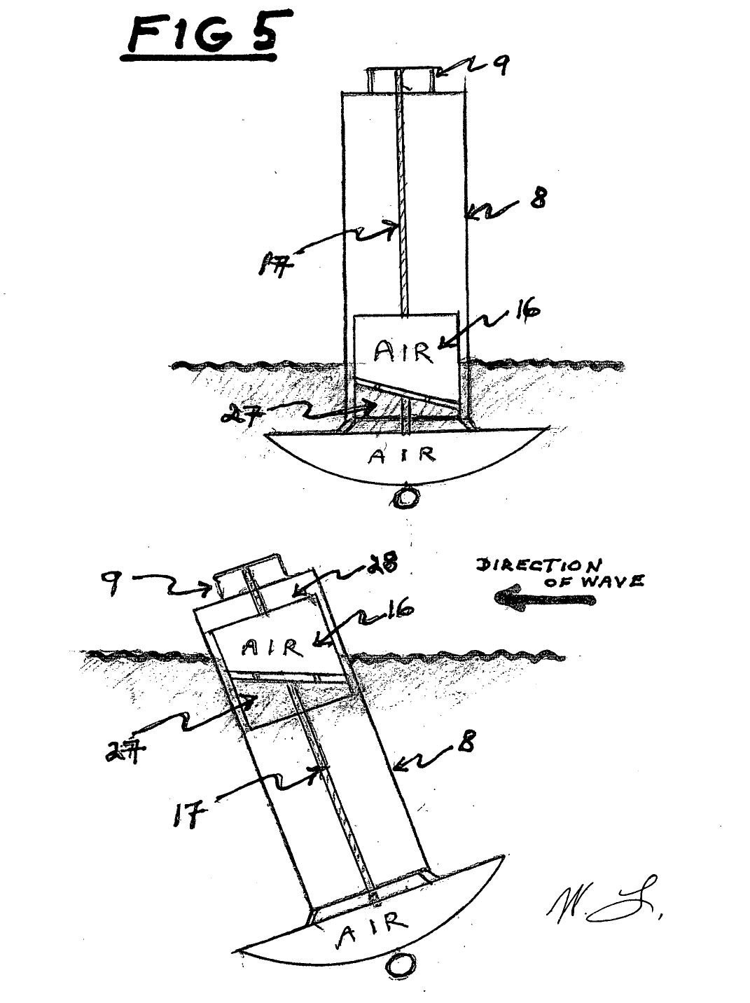

The unit is now depicted with the rear end fully submerged. When the float (16) is at its apex, the water holding it in suspension will commence to recede and the float will begin to descend, driven by the force of gravity. On the downward motion it will again spin the worm-geared shaft (17) that drives the generator (9) atop the unit. The force of the downward motion will be aided by the water ballast at the bottom of the float (as detailed in FIG. 5).

Once the wave has moved past the apparatus, the rear portion of the apparatus begins to rise again, lifted by the buoyancy tank (20) which is no longer subjected to the Bernoulli effect. The cable-suspended counter weight (17) will shift the center of gravity back to the front of the unit and will simultaneously drag the apparatus to its original position.

The downward pull the counterweight exerts on the front-mounted pulley (14b) which now becomes a drive pulley setting the twin turbines (3) in reverse motion, as well as the fact that the rear pulley (14a) is now allowed to idle, will cause the water trapped inside the channel (21) to move toward the twin turbines (3) further assisting in depressing the front end and thereby raising the rear end. After the water passes through the reversible turbines (3) producing a small amount of electricity, it will be expelled through the hinged gate (6) onto the ramp (4), where its weight on the extreme end of the apparatus will contribute to further depress the front end, thus increasing the rate of flow from the rear to the front of the apparatus.

When all the water is purged from the units and the floats have descended to their original buoyancy level, the cycle will repeat with the next approaching wave.

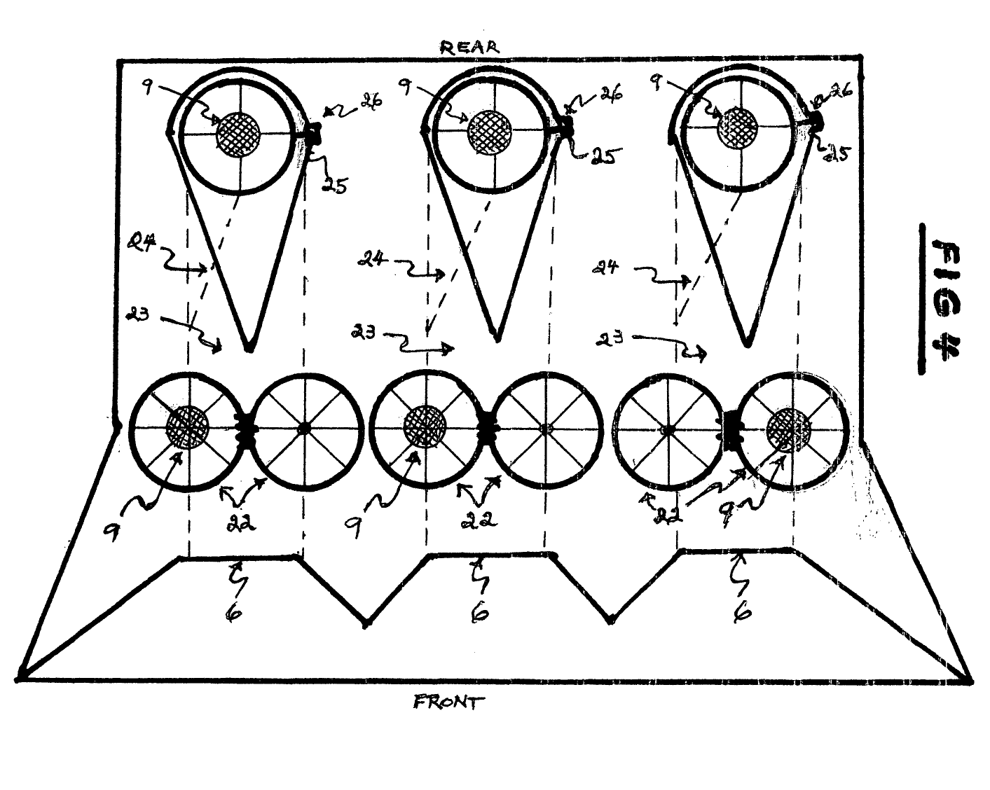

### FIG. 4

The top view of the apparatus showing the three joined units reveals the interaction of the twin turbines which are locked together by their geared outer rings (22), thus requiring only one generator (9) for each pair of turbines. Since the turbines are reversible, a small amount of electricity can be produced on the reverse movement of the water in the channel (23).

The baffles (24) are designed to deflect the water moving from front to rear to the slider (25) which prevents the float from turning when it drives the worm-geared shaft on its movement up and down. The pressure of the deflected water should help to reduce friction of the slider moving in the vertical channel (26).

### FIG. 5

When the apparatus is at rest between waves, the cylinders (8) at the rear are in a vertical position. The floats (16) inside the cylinders have an angled portion attached at the bottom (27) which is filled with water since it is open at the top. The reason for the slanted top is to allow a maximum of water to remain in this permanently attached portion of the float, when the float reaches its greatest height (28) and is then in a slanted position resulting from the depression of the rear of the apparatus.

The upward movement of the float is not impeded by the water-filled portion, since the air-filled part of the float remains partially submerged.

When the wave has passed and the rear of the apparatus begins to rise again, the float (16) will commence to descend driving the worm-geared shaft (17) which in turn drives the generator (9). Driving the generator acts as a brake in the downward movement of the float. Since the water thus recedes faster than the float descends, the ballast in the water-filled portion (27) of the float now adds increased weight and more driving power.

1) The twin turbines FIG. 1 (3) in this application are designed to extract a maximum of power by channeling water deflected from one turbine into the blades of the other turbine.

2) Extracting power from the rear pulley FIG. 2 (14a) causes the rear portion of the apparatus to be pulled under, which increases the length of stroke the float FIG. 3 (16) is forced to travel.

3) The water ballast FIG. 5 (27) at the bottom of the float FIG. 3 (16) increases the gravitational force during descent.

4) The configuration of the buoyancy tank FIG. 2 (20) brings the Bernoulli effect to bear when the wave sweeps under the apparatus, thus assisting in the downward pressure of the rear portion of the apparatus.

5) The combination of the above allows for maximum power extraction.
